(19) United States
(12) Patent Application Publication
(10) Pub. No.: US 2012/0114909 A1
(43) Pub. Date: May 10, 2012

(54) METHODS AND APPARATUS FOR REDUCING VOIDS IN A MOLDED PART

(75) Inventors: Christopher A. Leombruno, Upton, MA (US); Erik F. Item, West Barnstable, MA (US); Curtis B. Carlsten, Seekonk, MA (US)

(73) Assignee: Raytheon Company, Waltham, MA (US)

(21) Appl. No.: 12/943,497

(22) Filed: Nov. 10, 2010

(51) Int. Cl. B32B 1/00; B29C 45/34

(52) U.S. Cl. 428/172; 264/294; 425/129.1

(57) ABSTRACT

Methods and apparatus for a mold assembly to minimize voids in a molded product. The mold assembly can include a fill port aligned in relation to first surface feature of a part to be molded, a vent to provide an exit passage for bubbles associated with a second surface feature, and a fill angle scheme to minimize voids in the molded part.

### STATEMENT REGARDING FEDERALLY SPONSORED RESEARCH

This invention was made with government support under Contract No. N00014-99-2-0005 and subcontract No. ARL/MSA-043 ITO-01 awarded by the Department of the Navy. The government has certain rights in the invention.

### BACKGROUND

As is known in the art, products can be fabricated by filling a mold containing a part with a liquid material that hardens, such as by heating or exposure to ultraviolet light. This process allows a viscous, uncured material to enter a mold cavity and form into a final shape. During the execution of this type of molding, there are a number of parameters that are defined and managed to yield high quality parts. These parameters include, for example, material type, viscosity, part size, part shape, surface resistance on the mold and part, mold shape, mold and part materials, material fill speed, fill pressure, material and part temperature, surface finish, material thickness, and material pot life.

One issue in the molding process for parts and molds of certain shapes and materials is the formation of voids, e.g., bubbles, which can render the finished product unusable. The disadvantages of voids are well known to one of ordinary skill in the art. In some applications, excessive voids increase manufacturing cycle times and decrease acoustic performance of sensors, for example.

FIG. 1A shows a prior art mold 10 filled with a material 12 with a significant void 14. FIG. 1B shows a prior art mold 20 filled with a material 22 having a significant number of voids 24. In specific applications excessive voids increase manufacturing cycle times and decrease acoustic performance of sensors, for example.

### SUMMARY

The present invention provides method and apparatus for a mold that minimizes the formation of voids in the molded product by fill port orientation, vent placement, and/or mold assembly manipulation based upon part surface features, fill material, material viscosity, fill rate, and/or volume of material. With this arrangement, higher yields can be achieved since voids in the molded product are reduced. While exemplary embodiments of the invention are shown and described in conjunction with certain part surface features, materials, molded products, mold shapes, mold connect, disconnect features, etc., it is understood that embodiments of the invention are applicable to molding in general, in which it is desirable to reduce bubble formation.

In one aspect of the invention, a method comprises identifying a first surface feature on a part to be molded that can accumulate bubbles in a fill material as a mold of a mold assembly is filled with the fill material, having the mold assembly positioned to a first orientation when the mold assembly is filled at a first amount, and having the mold assembly positioned to a second orientation when the mold assembly is filled to a second amount, wherein manipulating the mold assembly to the first and second orientations minimizes bubbles associated with the first surface feature.

The method can further include one or more of the following features: the first surface feature includes an overhang on a surface of the part, the first surface feature includes an overhang formed by a cap, a fill port for the mold assembly, wherein the part includes a second surface feature that is substantially elongate with a longitudinal axis, wherein a direction of flow material from the fill port is generally parallel to the longitudinal axis of the second surface feature, the second surface feature includes a wire and the fill port is substantially parallel to the direction of flow material from the fill port, a locating a vent in the mold assembly in relation to the first surface feature to provide an exit path for the bubbles created by the first surface feature, and the vent is located on a side of the mold.

In another aspect of the invention, a method comprises: identifying an elongate first surface feature having a longitudinal axis on a part to be molded that can accumulate bubbles as a mold of a mold assembly is filled with a fill material, and locating a fill port for the mold assembly in relation to the longitudinal axis of the first surface feature such that a direction of flow of fill material from the fill port is generally parallel to the longitudinal axis of the first feature to reduce turbulence during the filling process.

The method can further include one or more of the following features: the first surface feature comprises at least one wire extending along a length of the part, and wherein the mold assembly includes an overfill cavity, placing a vent in the mold assembly in relation to a second surface feature of the part, the vent is configured to provide an exit passage for bubbles created by the second surface feature, which includes an overhang, the vent is located on a side of the mold, and manipulating a position of the mold assembly during the fill process to minimize bubbles from the second surface feature.

In a further aspect of the invention, a mold assembly comprises: a mold having a mold cavity, a part located in the mold cavity, the part having first and second surface features, and a fill port to fill the mold cavity with a fill material for fabricating a molded part, wherein the fill material flows from the fill port in a direction generally parallel to a longitudinal axis of the first surface feature on the part.

The mold assembly can further include one or more of the following features: an orientation mechanism to position the mold assembly in a first orientation when the mold assembly is filled at a first amount, and position the mold assembly at a second orientation when the mold assembly is filled to a second amount, wherein manipulating the mold assembly to the first and second orientations minimizes bubbles associated with a second surface feature on the part, and at least one vent located in relation to the second surface feature to provide an exit path for the bubbles associated with the second surface feature.

### BRIEF DESCRIPTION OF THE DRAWINGS

The foregoing features of this invention, as well as the invention itself, may be more fully understood from the following description of the drawings in which:

FIGS. 1A and 1B show prior art molds having voids in the fill material;

FIG. 2 is a schematic representation of an exemplary mold for minimizing voids in accordance with exemplary embodiments of the invention;

FIG. 3 is a schematic representation of a further exemplary mold for minimizing voids in accordance with exemplary embodiments of the invention;

FIG. 4 is a flow diagram showing an exemplary sequence of steps for fabricating a molded product with minimal voids in accordance with exemplary embodiments of the invention;

FIG. 5A is a schematic representation of a mold assembly at a first fill angle and a first stage of fill completion;

FIG. 5B is a schematic representation of a mold assembly at a second fill angle and a second stage of fill completion; and

FIG. 6 is a schematic representation of a part in a mold cavity of a mold assembly;

FIG. 6A is a schematic representation of a mold part and mold assembly; and

FIGS. 7A-G show molds having exemplary vent and side cavity configurations.

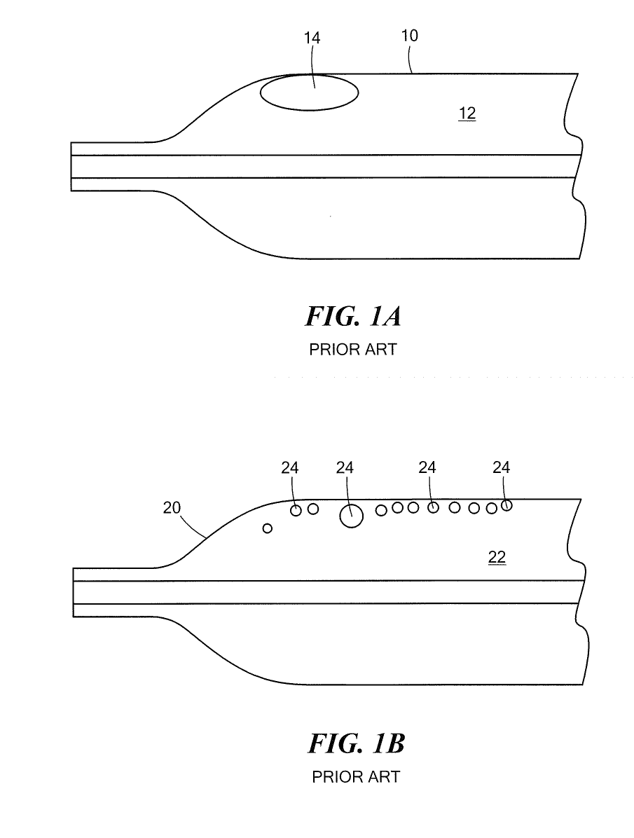

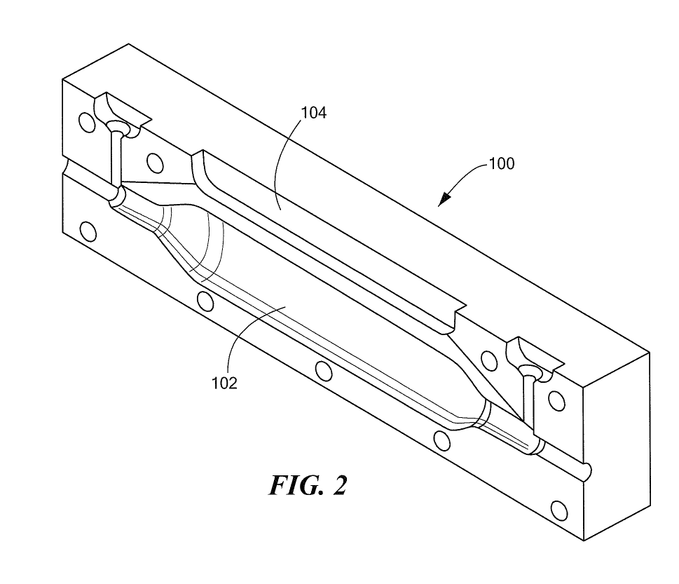

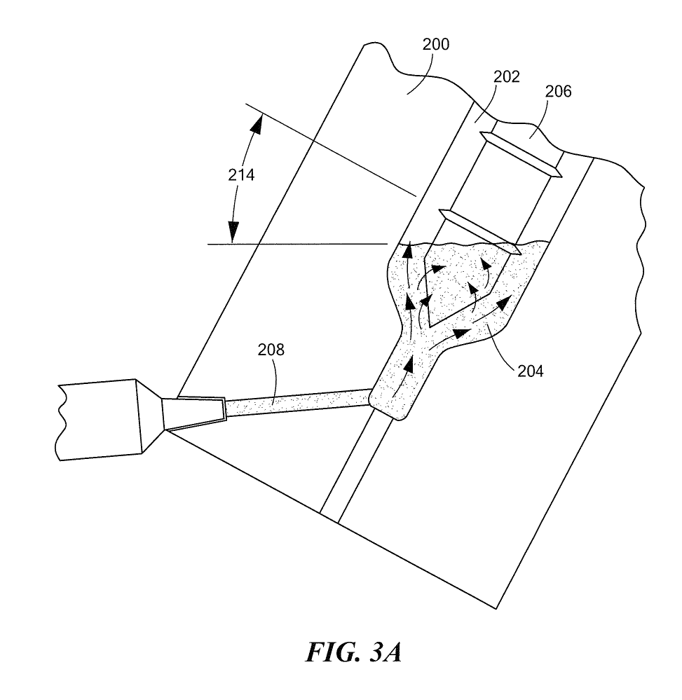

### DETAILED DESCRIPTION

FIG. 2 shows an exemplary mold assembly 100 to provide a molded product 102, shown as an acoustic sensor. In general, the mold assembly 100 moves air in the mold during the fill process so as to minimize voids in the product 102. One or more vents 104 operate in conjunction with the mold assembly at selected fill angles, as well as other parameters, to decrease the number and volume of voids, as described more fully below.

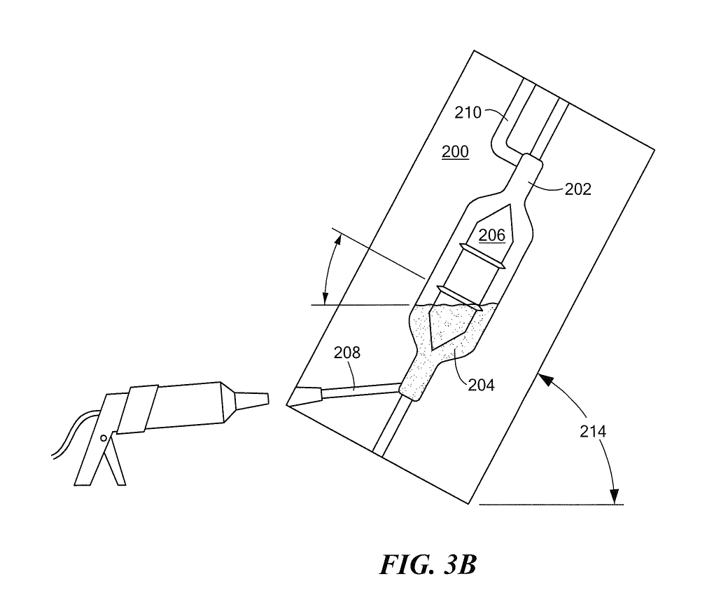

FIGS. 3A and 3B show a mold assembly 200 having a mold cavity 202 being filled with a fill material 204 to encapsulate an item 206, such as an acoustic sensor, to form a molded product. The material 204 is injected into the mold cavity 206 via a fill port 208 at a selected pressure. In an exemplary embodiment, the fill port 208 is located at a bottom of the mold assembly so that material fills in an upward direction. A combined vent/overfill port 210 is located at a top of the mold assembly to accept an overflow of material from the mold cavity 202. The vent/overfill port 210 also enables air to escape from the mold cavity 202 as material is injected. As described more fully below, the at least one vent/overfill port 212 facilitates the escape of air so as to minimize voids.

The mold assembly 200 is placed at a fill angle 214 so that the mold cavity 202 fills with the material at an angle. While the surface of the fill material 204 will be horizontal due to the forces of gravity, the fill angle 214 results in a desired angle of the material surface across the mold cavity and surface features of the part to minimize voids associated with complex features of the part during the fill process, as described more fully below.

While the molded product is shown as an acoustic sensor having an elongate geometry, it is understood that exemplary embodiments of the invention are applicable to any product type and shape in which it is desirable to minimize voids.

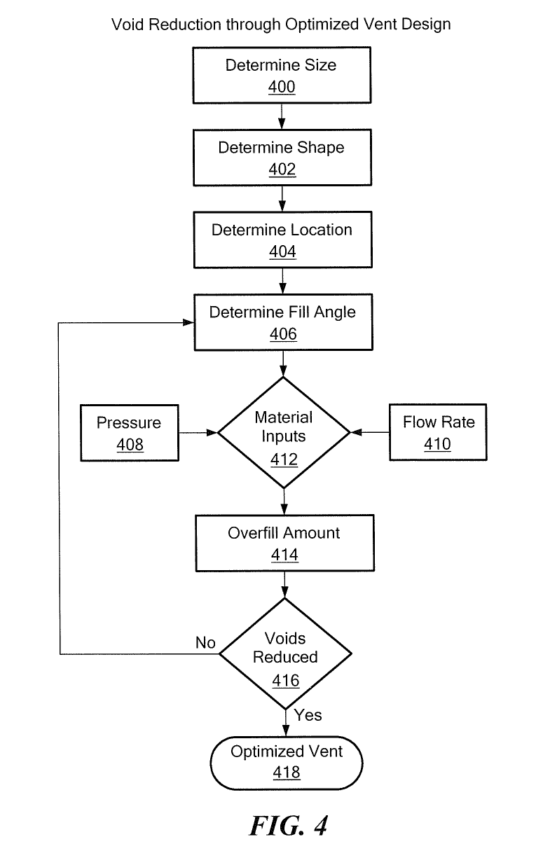

FIG. 4, in conjunction with FIGS. 3A and 3B, shows an exemplary sequence of steps for reducing voids in a mold in accordance with the present invention. In step 400, a size of the part and mold is determined and in step 402 the shape of the mold cavity is determined. From the size and shape, a volume of the mold can be determined.

In step 404, a location is determined for the mold assembly that minimizes turbulence during the filling process. In step 406, a fill angle is determined for the mold. The fill angle is selected to optimize the material flow to reduce material turbulence. Fill angle is determined by identifying surface features, such as overhangs, undercuts, holes or other significant features that may entrap bubbles or restrict flow around the molded part. The fill angle of the mold is selected to provide the cleanest material path during filling. If a single fill angle is insufficient, multiple fill angle adjustments may be made during the fill process in relation to the feature in the molded part.

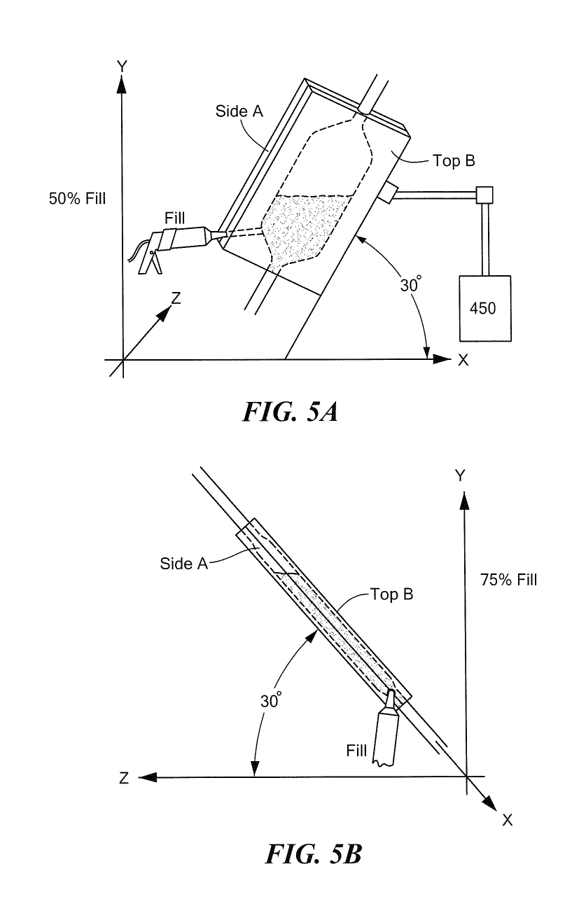

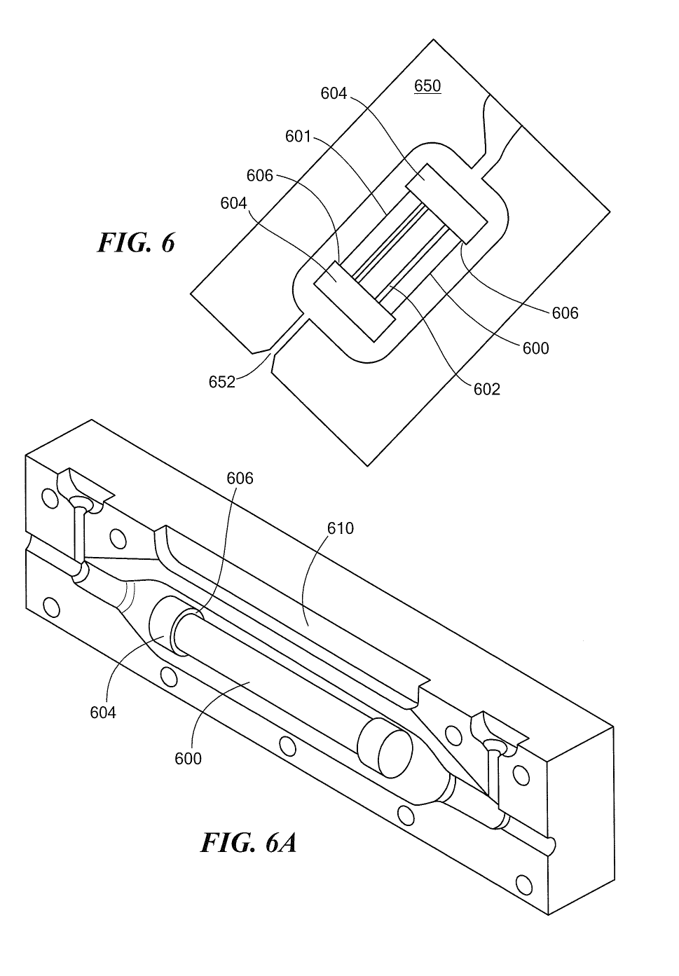

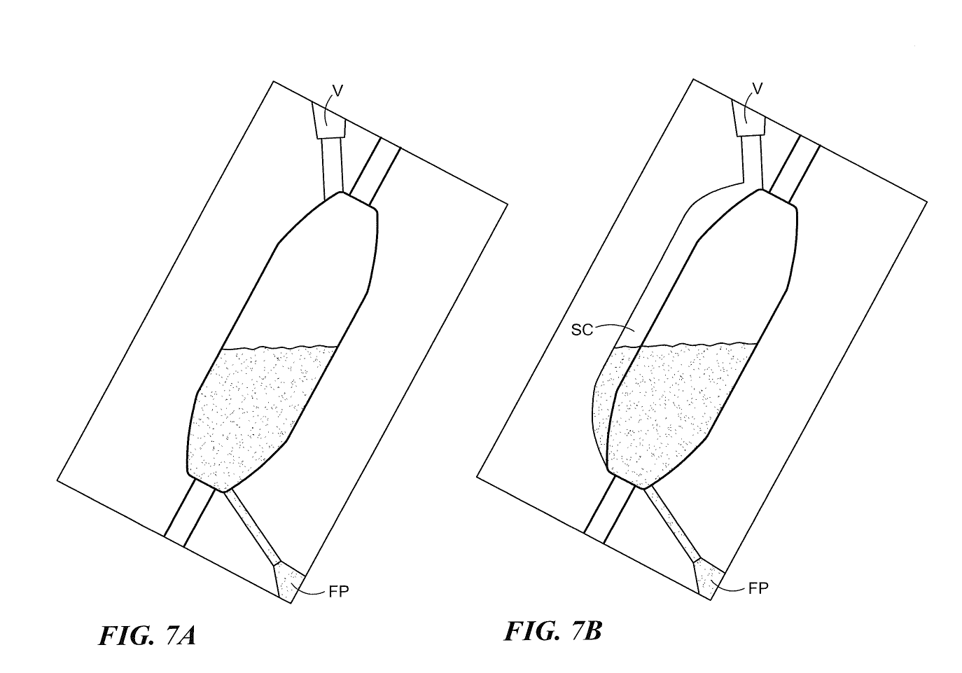

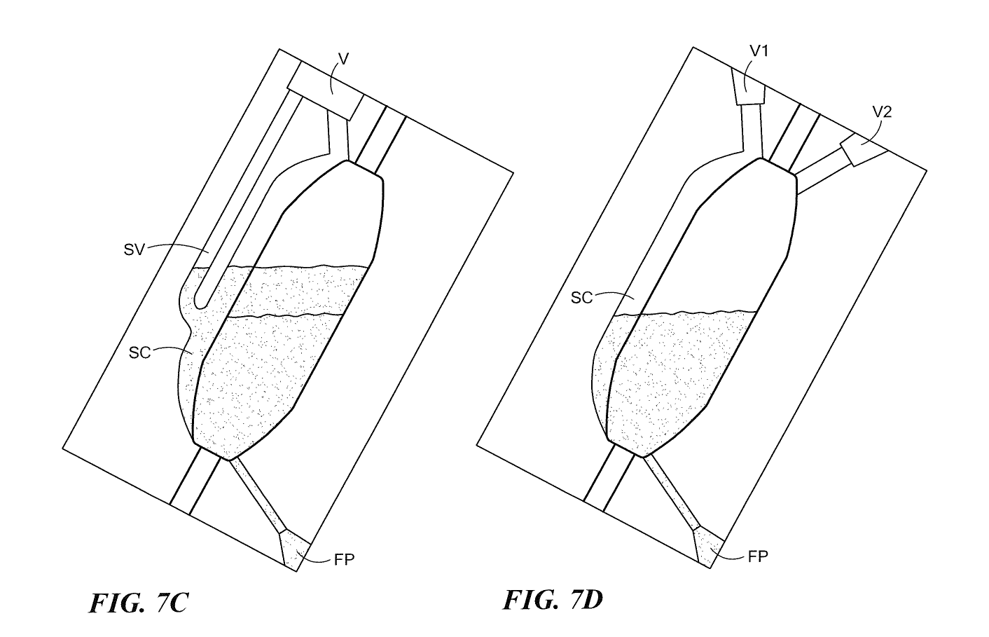

FIG. 5A shows a mold assembly about fifty percent filled having a side A and a top B at about a 30 degree angle with respect to the x-y plane. FIG. 5B shows the mold assembly seventy-five percent filled at about a thirty degree angle with respect to the y-z plane. In an exemplary embodiment, the fill angle ranges from about 30°±10°. Fill angle orientation (X,Y,Z axes) is determined by the shape, size, and surface feature geometry of the part to be molded. The fill angle should be set so the flow of material has the least amount of obstruction or undercuts in its path.

Multiple fill positions may be required to optimize flow and reduce voids during the filling process. For example, the mold is initially set mold at an angle of 30° in the X,Y plane and filled to 50% of the cavity, as shown in FIG. 5A. A feature on the part may require the mold to be rotated 30°, for example, in the Y,Z plane while filling of the mold cavity completes, as shown in FIG. 5B. In addition, the various fill angles can be selected for desired amount of times to achieve a given level of bubble dissipation.

In an exemplary embodiment, an orientation mechanism 450 manipulates the mold assembly to a desired orientation for a selected amount of time. In one embodiment, the orientation mechanism 450 moves the mold assembly in a relatively low speed constant motion. In general, the orientation mechanism can move the mold assembly at speeds and angles in three dimensions to meet the needs of a particular application.

Referring again to FIG. 4, in step 408, a pressure is selected and in step 410 a flow rate is selected as material inputs 412. Pressure and flow rate parameters are selected based on properties for a particular encapsulation material. In general, filling of the mold cavity is done as quickly as possible to reduce cycle time and maintain optimal material viscosity.

A variety of material and part quality parameters define the fill rate. Fill rate, which can be controlled by injection fill pressure, should not induce bubbles during cavity filling. For the case where a part contains specific features, such as undercuts, large overhanging features, significant changes in surface plane or surface recesses, the fill rate should be adjusted, e.g., lowered, to avoid bubble generation while the material flows into the mold cavity. Lower viscosity materials, short material pot life and material volume of the filled cavity define the nominal fill rate. The fill material can be ‘pulsed’ during the filling process to agitate entrapped bubbles for freeing the bubbles from entrapped areas or complex surfaces.

In step 414, an overfill amount is selected. The overfill volume (quantity) and duration is specified by determining an amount required for sufficient mold volume “flushing.” Flushing is required to clear bubbles or voids generated in the filling process or from complex surface features. The bubbles are moved through the mold and into the reservoir cavity by the excess material into the cavity during the overfill portion of the fill process.

The overfill cavity should be of sufficient size to accept the required overfill volume. In general, the overfill cavity is designed with significant reserve to be oversized, such as at least one quarter of the final part volume.

In step 416, it is determined whether voids in the mold are less than a size threshold and less than a number threshold. That is, it is determined whether the voids are less than a certain size and whether the number of voids is sufficiently small. In an exemplary embodiment, void volume is determined from visual inspection post cure to determine whether specific molding requirements are met. Measurement techniques include scales, calipers, inspection eye loupes with graduated scales and microscopes. If the voids are less than the size and number threshold, it is determined that the vent is optimized in step 416. If not, the process is adjusted to achieve the desired levels of void size and number.

Vent size (diameter of vent port or overall volume of the vent port) should be at least two times the diameter of the fill port. The vent port can be sized larger than the fill port to ensure the maximum sized bubble that entered the molded cavity from the fill port will easily pass through the molded cavity and exit the vent. Vent size may also be enlarged to allow for material curing, which restricts material flow. The larger vent port improves flow into the overfill cavity.

As noted above, specific part features, such as cavities, undercuts, and complex surfaces can increase bubble or void frequency in molded parts. In general, part features that can generate excessive voids are mapped. A mold is designed to mitigate flow and turbulence of the material during the molding process. The molds are designed to improve material flow into, through and out of the mold. The improvement in material is achieved by identifying to the extent possible optimal fill and vent quantity, sizes, angles and locations after identifying areas in the mold that may restrict or alter the normal flow of the material into the mold. By focusing on these areas, the mold and the molding process are designed with attention given to vent and filling design, as well as mold and part angle, as described below.

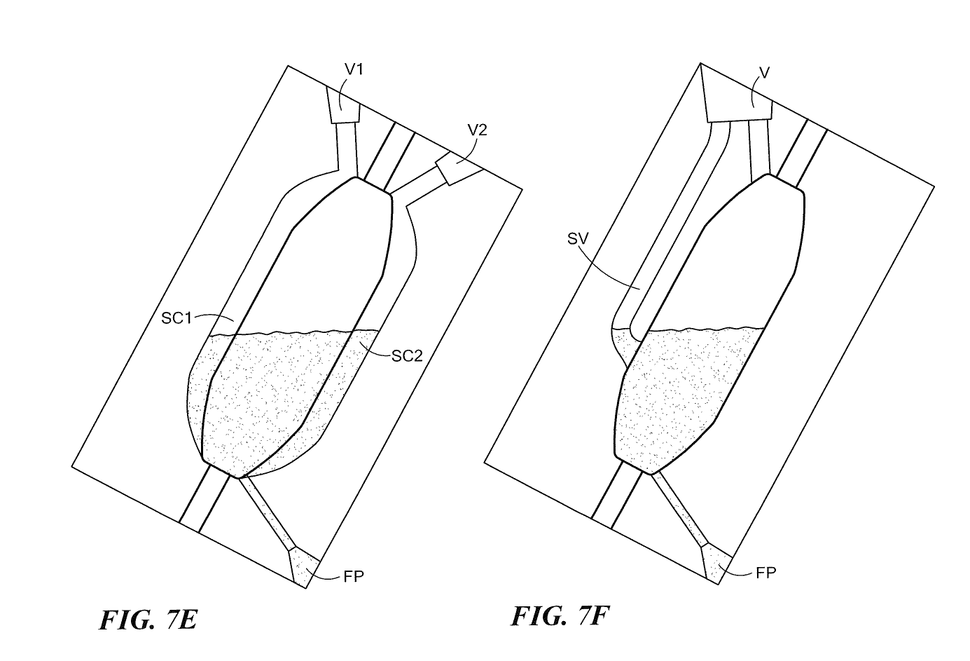

In an exemplary embodiment shown in FIG. 6, a molded part 600 includes a cylinder 601 having multiple wires 602 running longitudinally along an outer surface. The cylinder 601 also includes caps 604 on each end that contain an overhang (pocket) 606 that may cause flow turbulence during filling. In one embodiment, the wires 602 are adjacent, e.g., abut up against, the part 600 which will make the filling material turbulent as it flows across these irregular surfaces.

The mold 650 includes one or more fill ports 652 that decrease flow turbulence by locating the fill port such that material flows from the fill ports in a direction that is similar to the wires 602. With this arrangement, the fill ports 652 direct the material to flow along the length of the wires, and not across the wires. It is understood that material flow across the wires 602, as opposed to along the wires, results in significantly more turbulence during the fill process, which increases likeliness of bubbles and voids.

To minimize bubbles and voids created by the cap overhangs 606, the fill angle of the mold and venting of the mold take into account the location of the overhangs 606. In one embodiment, the cap overhangs 606 are perpendicular to the wires 602 and nominal material flow. As shown in FIG. 5A, during at least part of the fill process, the mold is angled to about 30 degrees for a period of time to allow trapped bubbles about the overhangs 606 to dissipate in the flowing material path.

To further enhance bubble/void reduction, mold vents 610 are located directly above the cap overhangs 606 as shown in FIG. 6A to provide an exit path for the bubbles flowing from area of the overhangs. By aligning the vents 610 with the overhang 606 areas, bubbles are quickly removed to prevent them from passing through the entire molded cavity. The process of venting bubbles at the point of origin allows flushing of the mold the cavity to remove bubbles without driving the bubbles further into the mold and increasing chances of voids.

As used herein, a vent refers to a passage, pocket, hole or other opening into the mold cavity to allow excess material, bubbles and/or potential material contaminates to exit the molded volume during the fill process. The vent provides a path for turbulent material and/or contaminates to exit the molded volume during filling. The vent can extend for a relatively small length of the part or for an entirety of the part/mold length to the meet the needs of a particular application.

In general, vents can have any suitable geometry, such as round or oval to enable the use of common machining tools and techniques for making the molds or molded volumes. The vents should ease the flow of material. To this end, the shape of the vent and its transition from the molded volume into the vent cavity/space should be smooth. Transitions with large fillets (rounded corners) generally provide optimal flow characteristics.

In an exemplary embodiment, the vent is located near a feature in the part of the mold that restricts material flow, such as an overhanging feature described below. The vent(s) are located and configured to improve the material path (or flow) around the part to be molded. Vents are typically located on the top or sides of the mold. The top/side locations allow voids and bubbles, which tend to float to the surface of the material, to escape during mold filling.

Side cavities are typically used to allow large pockets or groups of bubbles to escape. These larger cavities are typically located on the sides of the molded volume and provide extended areas for contaminates and bubbles to migrate during filling. These larger side cavities also can be used as an overfill volume during faster filling or so-called ‘flushing’ techniques. This ‘flushing’ process and side vent orientation assists with the more complex molded parts that require the trapped voids to be forced or flushed out of the cavity.

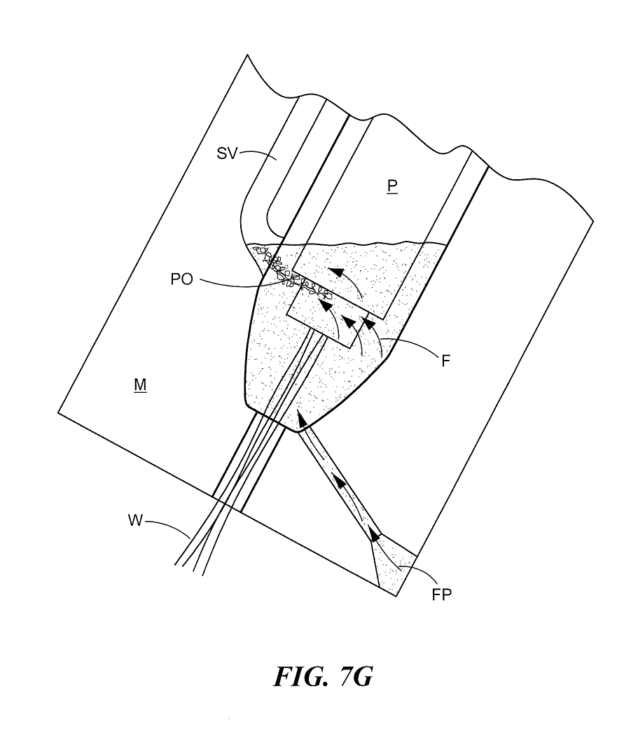

FIGS. 7A-G show exemplary mold vent configurations. FIG. 7A shows a mold having a top vent V and a bottom fill port FP. FIG. 7B shows a mold having a top vent V and a side cavity SC. FIG. 7C shows a mold having a top vent V, a side cavity, SC, and a side vent SV. FIG. 7D shows a mold having first and second top vents V1, V2, a side cavity SC, and a bottom fill port FP. FIG. 7E shows a mold having dual side cavities SC1, SC2, and dual top vents V1, V2. FIG. 7F shows a mold having a top vent V and a side vent SV. FIG. 7G shows a mold M having a side vent SV located proximate a part overhang PO. This arrangement facilitates the movement of material turbulence into the vent SV to reduce voids as the material flows F to the vent. The illustrated part P has wires W extending from an end.

It is understood that a variety of suitable mold materials can be used to mold parts. A wide range of materials that are pourable or capable of being pressure fed will be readily apparent to one of ordinary skill in the art. It is further understood that parts having virtually any geometry can be molded in accordance with exemplary embodiments of the invention. In addition, pressures used to inject the mold material can be selected to meet the needs of a particular application. Exemplary pressures range from about 15 to about 30 psi.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
having the mold assembly positioned to a first orientation when the mold assembly is filled at a first amount; and
having the mold assembly positioned to a second orientation when the mold assembly is filled to a second amount,
wherein manipulating the mold assembly to the first and second orientations produces less bubbles associated with a first surface feature than if the mold assembly was not manipulated into the first and second orientations, the first surface feature corresponding to a feature on a part to be molded that can accumulate bubbles in a fill material as a mold of the mold assembly is filled with the fill material.

2. The method according to claim 1, wherein the first surface feature includes an overhang on a surface of the part.

3. The method according to claim 1, wherein the first surface feature includes an overhang formed by a cap.

4. The method according to claim 1, further including a fill port for the mold assembly, wherein the part includes a second surface feature that is substantially elongate with a longitudinal axis, wherein a direction of flow material from the fill port is generally parallel to the longitudinal axis of the second surface feature.

5. The method according to claim 4, wherein the second surface feature includes a wire and the fill port is substantially parallel to the direction of flow material from the fill port.

6. The method according to claim 1, further including a locating a vent in the mold assembly in relation to the first surface feature to provide an exit path for the bubbles created by the first surface feature.

7. The method according to claim 6, wherein the vent is located on a side of the mold.

8. A molded part comprising a sound transducer fabricated by the method of claim 1.

9. A method, comprising:
locating a fill port for the mold assembly in relation to a longitudinal axis of an elongate surface feature of a part to be molded that can accumulate bubbles as a mold of the mold assembly is filled with a fill material such that a direction of flow of the fill material from the fill port is generally parallel to the longitudinal axis of the first feature to generate less turbulence during the filling process than if the direction of flow is not generally parallel to longitudinal axis.

10. The method according to claim 9, wherein the first surface feature comprises at least one wire extending along a length of the part, and wherein the mold assembly includes an overfill cavity.

11. The method according to claim 9, further including placing a vent in the mold assembly in relation to a second surface feature of the part.

12. The method according to claim 11, wherein the vent is configured to provide an exit passage for bubbles created by the second surface feature, which includes an overhang.

13. The method according to claim 11, wherein the vent is located on a side of the mold.

14. The method according to claim 9, further including manipulating a position of the mold assembly during the fill process to minimize bubbles from the second surface feature.

15. A molded part fabricated by the method of claim 9.

16. A mold assembly, comprising:
a mold having a mold cavity;
a part located in the mold cavity, the part having first and second surface features; and
a fill port to fill the mold cavity with a fill material for fabricating a molded part, wherein the fill material flows from the fill port in a direction generally parallel to a longitudinal axis of the first surface feature on the part.

17. The assembly according to claim 16, further including an orientation mechanism to position the mold assembly in a first orientation when the mold assembly is filled at a first amount, and position the mold assembly at a second orientation when the mold assembly is filled to a second amount, wherein manipulating the mold assembly to the first and second orientations minimizes bubbles associated with a second surface feature on the part.

18. The assembly according to claim 17, further including at least one vent located in relation to the second surface feature to provide an exit path for the bubbles associated with the second surface feature.
